(19) United States
(12) Patent Application Publication
(10) Pub. No.: US 2015/0022704 A1
(43) Pub. Date: Jan. 22, 2015

(54) Orientation-Based Camera Operation

(71) Applicant: LSI Corporation, Lehigh Valley Campus, PA (US)

(72) Inventors: Roger A. Fratti, Mohnton, PA (US); Albert Torressen, Bronx, NY (US); James McDaniel, Nazareth, PA (US)

(73) Assignee: LSI Corporation, Lehigh Valley Campus, PA (US)

(21) Appl. No.: 13/954,084

(22) Filed: Jul. 30, 2013

Related U.S. Application Data
(60) Provisional application No. 61/847,815, filed on Jul. 18, 2013.

(51) Int. Cl. H04N 5/232

(52) U.S. Cl. CPC H04N 5/23216
USPC 348/333.01

(57) ABSTRACT

An electronic device comprising an image sensor, an orientation sensor, and a user interface, may be operable to capture photographs via the image sensor. Input to the user interface required for triggering a photo capture may depend on an orientation of the electronic device indicated by the orientation sensor. Input required to trigger a photo capture while the orientation sensor indicates a first orientation of the electronic device may be different than input required to trigger a photo capture while the orientation sensor indicates a second orientation of the electronic device.

### PRIORITY CLAIM

This patent application makes reference to, claims priority to and claims benefit from U.S. Provisional Patent Application Ser. No. 61/847,815 titled “Orientation-Based Camera Operation” and filed on Jul. 18, 2013, which is hereby incorporated herein by reference in its entirety.

### FIELD OF INVENTION

Aspects of the present application relate to devices with camera functionality. More specifically, to methods and systems for sensor-based camera operation.

### BACKGROUND

Conventional cameras are often inadvertently triggered resulting in capture of undesired photos. Further limitations and disadvantages of conventional and traditional approaches will become apparent to one of skill in the art, through comparison of such approaches with approaches set forth in the remainder of this disclosure with reference to the drawings.

### SUMMARY

An electronic device comprising an image sensor, an orientation sensor, and a user interface, is operable to capture photographs via the image sensor. Input to the user interface required for triggering a photo capture depends on an orientation of the electronic device indicated by the orientation sensor.

### BRIEF DESCRIPTION OF FIGURES

FIG. 1 is block diagram of an example electronic device operable to perform a camera function.

FIG. 2 depicts multiple views of an example electronic device operable to perform a camera function.

FIG. 3 depicts an example interface for configuring camera functionality of an electronic device.

FIG. 4 illustrates multiple orientations of an electronic device operable to perform a camera function.

FIG. 5A illustrates a change in photo capture mode with change in orientation of the electronic device.

FIG. 5B illustrates an example photo capture while the orientation of the electronic device is within a predetermined range.

FIG. 5C illustrates an example photo capture while the orientation of the electronic device is outside a predetermined range.

FIGS. 6-10 illustrate example photo captures while the orientation of the electronic device is outside a predetermined range.

FIG. 11 is a flowchart illustrating an example process for guarding against inadvertent photos.

FIG. 12 is a flowchart illustrating an example process for guarding against inadvertent photos.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

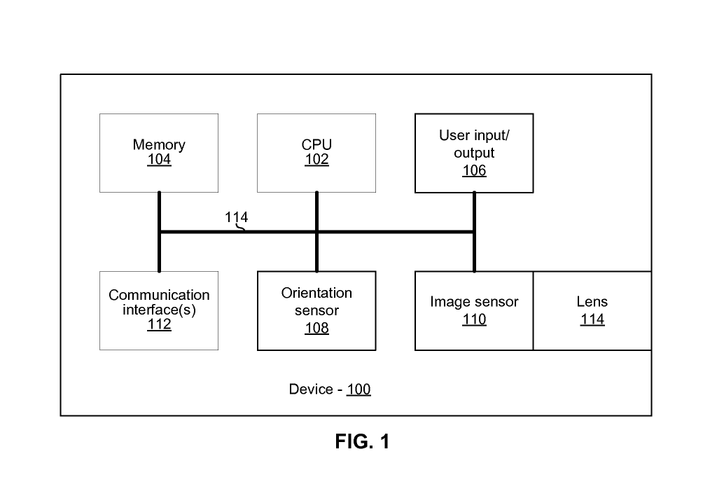

FIG. 1 is block diagram of an example electronic device operable to perform a camera function. The device 100 may be, for example, a standalone camera or may be a multi-function portable device (e.g., phone, tablet computer, wireless terminal or the like) with camera functionality. The example device 100 comprises a central processing unit (CPU) 102, memory 104, user input/output circuitry 106, an orientation sensor 108, an image sensor 110, communication interface circuitry 112, and an optical lens 114.

The CPU 102 is operable to process data, and/or control and/or manage operations of the electronic device 100, and/or tasks and/or applications performed therein. The CPU 102 is operable to configure and/or control operations of various components and/or subsystems of the electronic device 100, by utilizing, for example, one or more control signals. The CPU 102 enables execution of code (e.g., operating system code, application code, etc.) which may be, for example, stored in memory 104.

The memory 104 comprises one or more arrays of memory and associated circuitry that enables storing and subsequently retrieving data, code and/or other information, which may be used, consumed, and/or processed. The memory 104 may comprise volatile and/or non-volatile memory. The memory 104 may comprise different memory technologies, including, for example, read-only memory (ROM), random access memory (RAM), Flash memory, solid-state drive (SSD), field-programmable gate array (FPGA) and/or any other suitable type of memory. The memory 104 stores, for example, configuration data, program code, and/or run-time data.

The user input/output (I/O) circuitry 106 enables a user to interact with the electronic device 100. The I/O circuitry 106 may support various types of inputs and/or outputs, including video (e.g., via the lens 114 and image sensor 110), audio (e.g., via a microphone of the circuitry 106), and/or text. I/O devices and/or components, external or internal, may be utilized for inputting and/or outputting data during operations of the I/O circuitry 106. The I/O subsystem may comprise, for example, a touchscreen and/or one or more physical (“hard”) controls (e.g., buttons, switches, etc.). Where the circuitry 106 comprises a touchscreen, it may be, for example, a resistive, capacitive, surface wave, infrared touchscreen or other suitable type of touchscreen.

The orientation sensor 108 comprises circuitry operable to detect an orientation of the electronic device 100 relative to a reference point or plane. For example, the orientation sensor 108 may use microelectromechanical system (MEMS) technology or other suitable type of orientation sensor technology that determines orientation based on gravitational forces acting on the orientation sensor 108.

The image sensor 110 comprises circuitry operable to convert optical image into an electric signal. The sensor 110 may use, for example, a charge-coupled device (CCD) image sensor, a complementary-metal-oxide-semiconductor (CMOS) image sensor or other suitable type of image sensor.

The communication interface circuitry 112 is operable to perform various functions for wireline and/or wireless communications in accordance with one or more protocols (e.g. Ethernet, USB, 3GPP LTE, etc.). Functions performed by the communication interface circuitry 112 may include, for example: amplification, frequency conversion, filtering, digital-to-analog conversion, encoding/decoding, encryption/decryption, modulation/demodulation, and/or the like.

The optical lens 114 comprises a lens (glass, polymer or the like) for focusing light rays onto the image sensor 110.

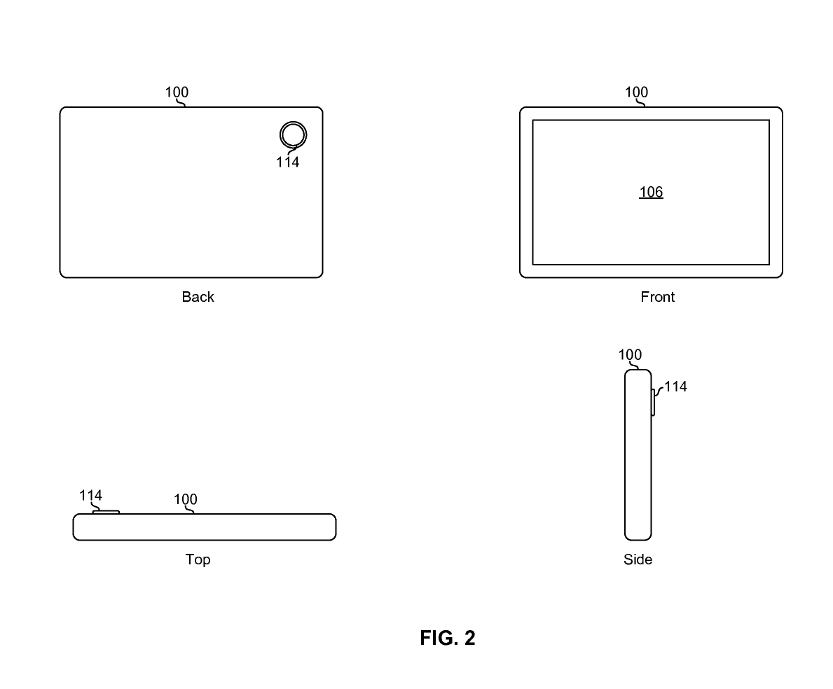

FIG. 2 depicts multiple views of an example electronic device operable to perform a camera function. Shown in the top-left of FIG. 2 is a view of the back of the device 100 on which the lens 114 can be seen. Shown in the top-right of FIG. 2 is a view of the front of the electronic device 100 on which user I/O 106 (in this instance, a touchscreen) can be seen. Shown in the bottom left of FIG. 2 is a top view of the device 100 from which the lens 114 can be seen. Shown in the bottom right of FIG. 2 is a side view of the device 100 from which the lens 114 can be seen.

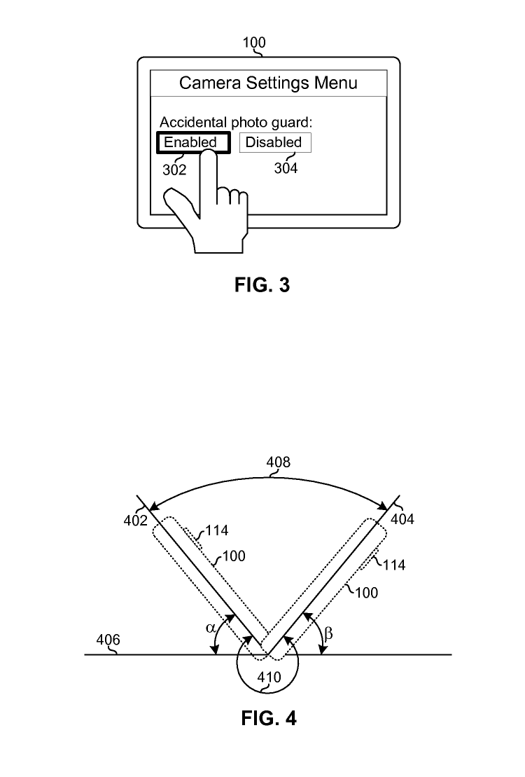

FIG. 3 depicts an example interface for configuring camera functionality of an electronic device 100 (FIG. 1). The interface enables a user to navigate (e.g., via a hierarchy of menus) to a camera settings menu where the user is presented with the option to enable, via control 302, or disable, via control 304, a feature of the device 100 that operates to reduce the occurrence of inadvertently captured photographs (e.g., to prevent accidentally taking a photograph of the ground while trying to prepare the device 100 for capturing a desired photograph).

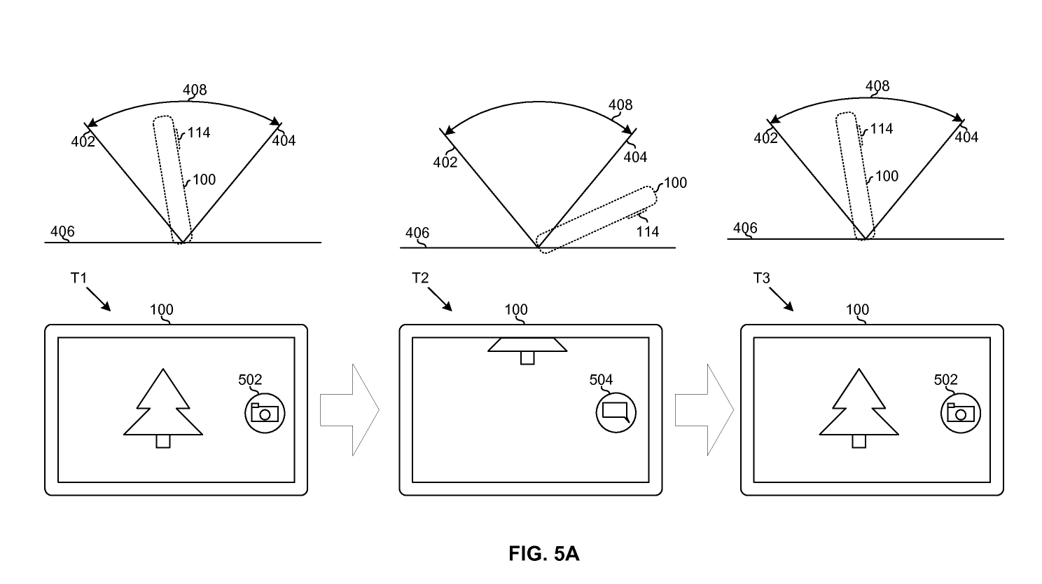

FIG. 4 illustrates multiple orientations of an electronic device 100 (FIG. 1) operable to perform a camera function. In the example implementation shown, orientation of the device is referenced to the line or plane 406. The line or plane 406 may correspond to the ground, for example. Shown is a first example orientation of device 100 which is described by the angle (α) between line 406 and line 402, and a second example orientation of the device 100 which is described by the angle (β) between line 406 and 404. In an example implementation, the orientation of the device 100 being within a determined range (e.g., in the range of angles indicated by line 408) causes the camera function of the device 100 to operate in a first mode, while the orientation of the device 100 being outside the determined range (e.g., in the range of angles indicated by line 410) causes the camera function of the device 100 to operate in a second mode. The determined range may be configured by a manufacturer of the device 100 and/or may be configured by a user of device 100 via the camera settings menu described above with respect to FIG. 3.

In an example implementation, a goal of the multi-mode operation of the device 100 is to reduce accidental capture of unintended photos. In another example implementation, a goal of the multi-mode operation of the device 100 is to improve quality of captured photographs. For example, different exposure times, aperture settings, flash settings, and/or the like may be used in the different modes.

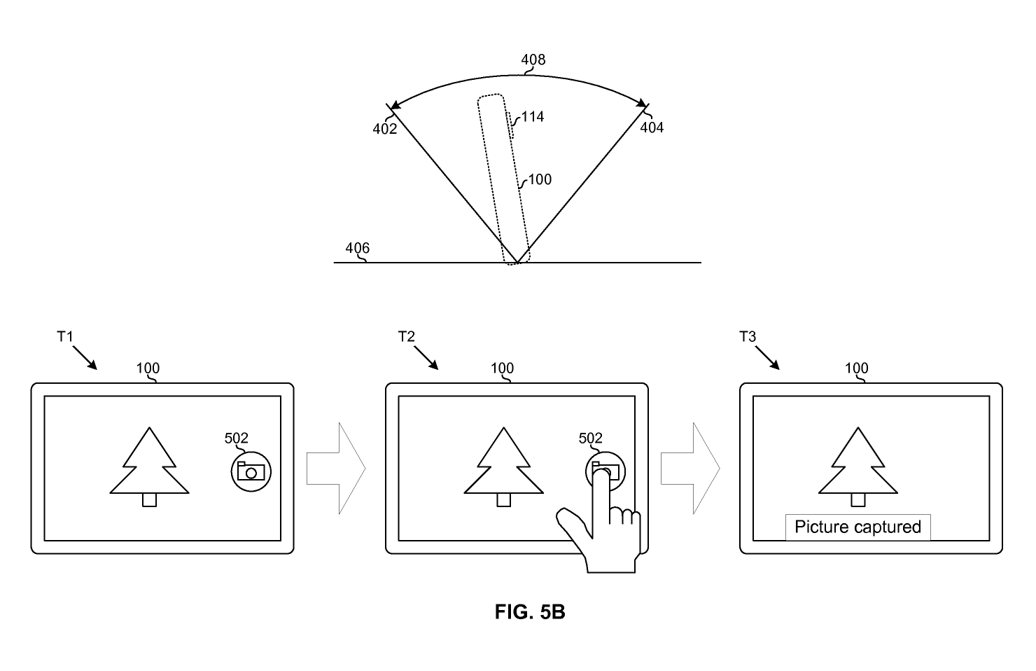

FIG. 5A illustrates a change in photo capture mode with change in orientation of the electronic device. In FIG. 5A, at time T1, the orientation of the device 100 is within the range indicated by line 408. Accordingly, at time T1, the device 100 is in a first mode in which photo capture is triggered in response to a first-mode user input. In the example implementation depicted in FIG. 5A, the first-mode user input is a touch of button 502. At time T2, the orientation of the device 100 is outside the range indicated by line 408. Accordingly, at time T2, the device 100 is in a second mode in which photo capture is triggered in response to a second mode user input. In the example implementation depicted in FIG. 5A, the second-mode user input is an audio command (e.g., “take picture”), as indicated by the interface element 504). At time T3, the orientation of the device 100 is again inside the range indicated by line 408. Accordingly, at time T3, the device 100 has returned to the first mode.

FIG. 5B illustrates an example photo capture while the orientation of the electronic device 100 is within a predetermined range. As shown at the top of the figure, the orientation of the device 100 in FIG. 5B is within the range indicated by line 408. Accordingly, in FIG. 5B, a photograph is triggered in response to a first-mode input. At time T1 in FIG. 5, the device 100 is ready to take a photograph. For example, where the device 100 is a phone or a tablet, a camera application of the device has been launched and is waiting for user input. In the example implementation depicted in FIG. 5B, the first-mode input is a single touch of button 502. Accordingly, at time T2, a photo capture is triggered when button 502 is pressed and the captured photo is available a short time later (e.g., based on processing delays, exposure time, etc.) at time T3.

FIG. 5C illustrates an example photo capture while the orientation of the electronic device is outside a predetermined range. As shown at the top of the figure, the orientation of the device 100 in FIG. 5C is outside the range indicated by line 408. Accordingly, in FIG. 5C, a photograph is triggered in response to a first-mode input. At time T1 in FIG. 5C, the device 100 is ready to take a photograph. For example, where the device 100 is a phone or a tablet, a camera application of the device has been launched and is waiting for user input. In the example implementation depicted in FIG. 5C, the second-mode input is a voice command. Accordingly, at time T2, a photo capture is triggered when the voice command is issued and the captured photo is available a short time later (e.g., based on processing delays, exposure time, etc.) at time T3.

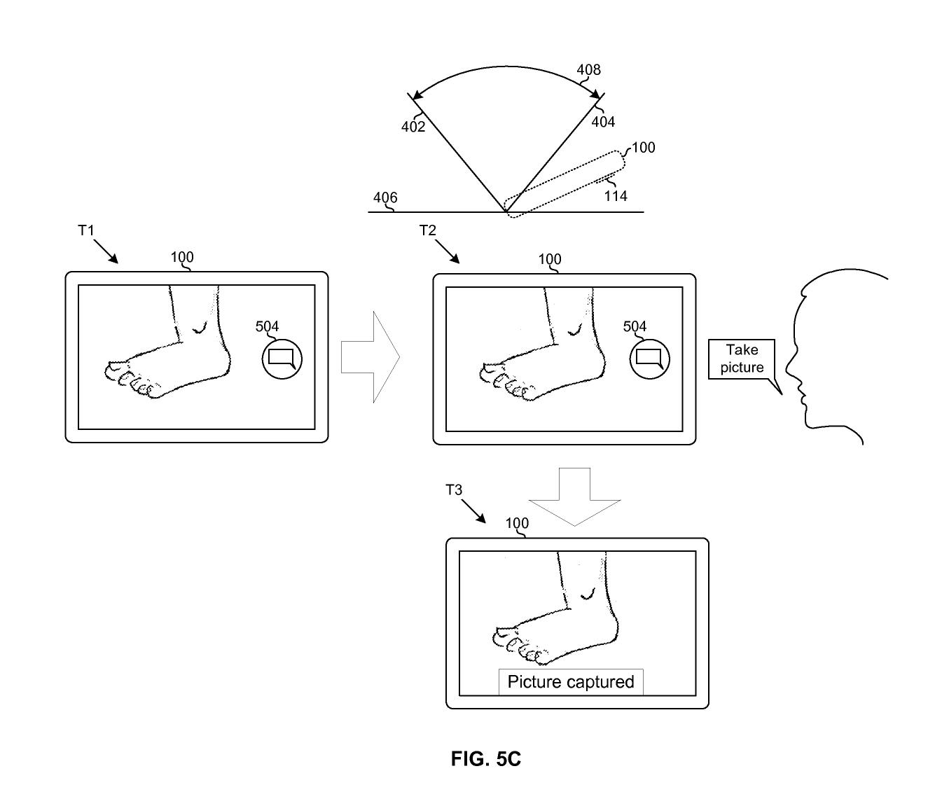

Now referring to FIG. 6, as shown at the top of the figure, the orientation of the device 100 in FIG. 6 is outside the range indicated by line 408. Accordingly, in FIG. 6, a photograph is triggered in response to a second-mode input. At time T1 in FIG. 6, the device 100 is ready to take a photograph. In the example implementation depicted in FIG. 6, the second-mode input is a combination of a touch of button 502 and a verbal command. Accordingly, in response to a touch of button 502 at time T2, the device transitions to a state in which it is waiting for an audio command. When the audio command is provided at time T3, a photo capture is triggered and the captured photo is available a short time later (e.g., based on processing delays, exposure time, etc.) at time T4. In an example implementation, if the voice command does not occur within a determined amount of time of the touch of button 502, then a timeout may occur and the device 100 may return to the state it was in at time T1.

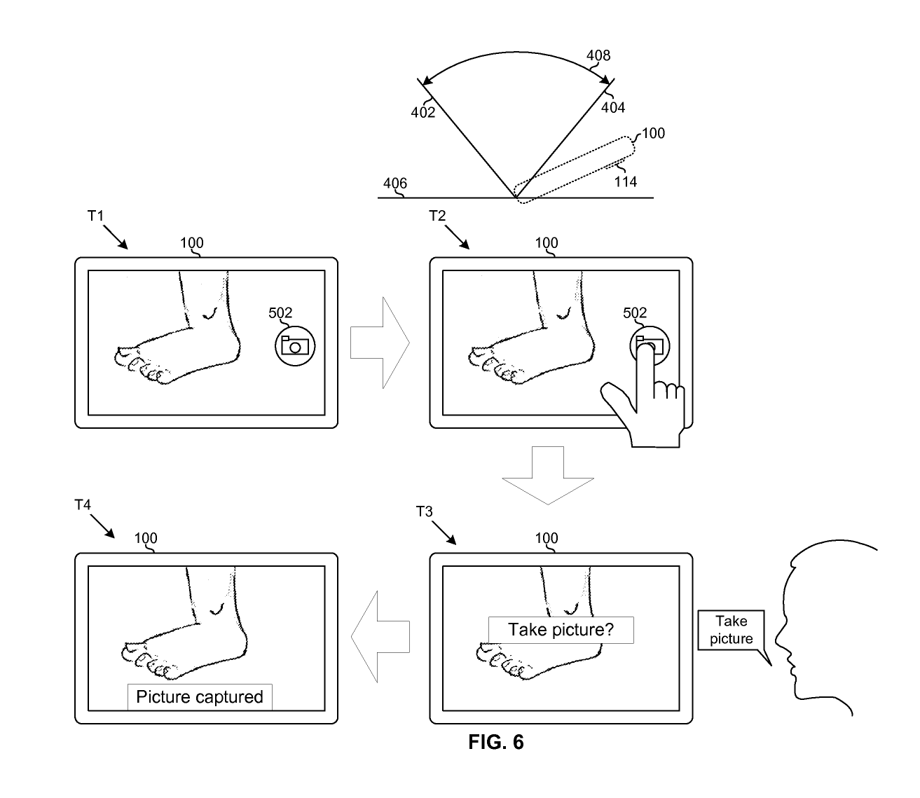

Now referring to FIG. 7, as shown at the top of the figure, the orientation of the device 100 in FIG. 7 is outside the range indicated by line 408. Accordingly, in FIG. 7, a photograph is triggered in response to a second-mode input. At time T1 in FIG. 7, the device 100 is ready to take a photograph. In the example implementation depicted in FIG. 7, the second-mode input is a sequence of button touches. Accordingly, in response to a touch of button 502 at time T2, a button 702 appears and the device 100 waits for a touch of button 702. When the button 702 is touched at time T3, a photo capture is triggered and the captured photo is available a short time later (e.g., based on processing delays, exposure time, etc.) at time T4. As shown in FIG. 7, button 702 may be at a different location than button 502 to reduce the risk of an inadvertent double touch that triggers photo capture. In an example implementation, if the touch of button 702 does not occur within a determined amount of time of the touch of button 502, then a timeout may occur and the device 100 may return to the state it was in at time T1.

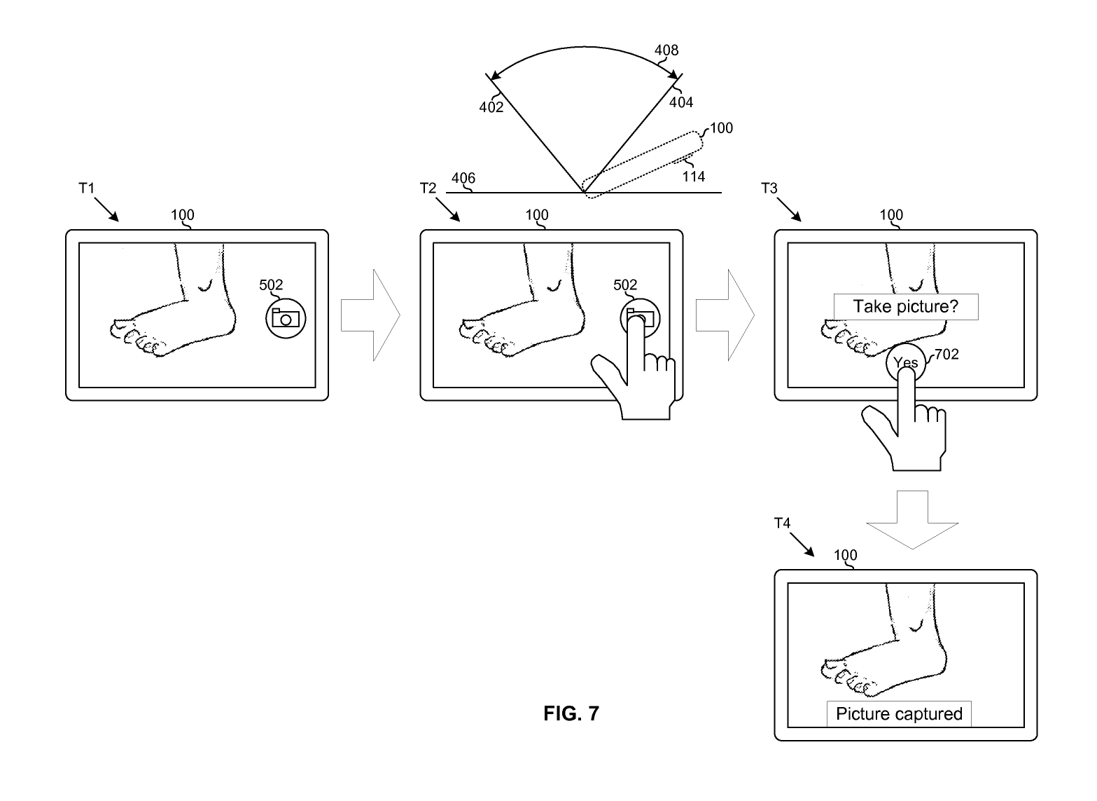

Now referring to FIG. 8, as shown at the top of the figure, the orientation of the device 100 in FIG. 8 is outside the range indicated by line 408. Accordingly, in FIG. 8, a photograph is triggered in response to a second-mode input. At time T1 in FIG. 8, the device 100 is ready to take a photograph. In the example implementation depicted in FIG. 8, the second-mode input is a concurrent press of buttons 502₁ and 502₂. The likelihood of an inadvertent concurrent touch of buttons 502₁ and 502₂ may be less than the likelihood of an inadvertent first-mode input such as the touch of the single button 502 in FIG. 5. Accordingly, in response to a concurrent touch of buttons 502₁ and 502₂ at time T2, a photo capture is triggered and the captured photo is available a short time later (e.g., based on processing delays, exposure time, etc.) at time T3. As shown in FIG. 8, buttons 502₁ and 502₂ may be spaced apart so as to reduce the risk of concurrently touching them with a single finger (e.g., each buttons may be positioned where they may be concurrently pressed by the user's two thumbs).

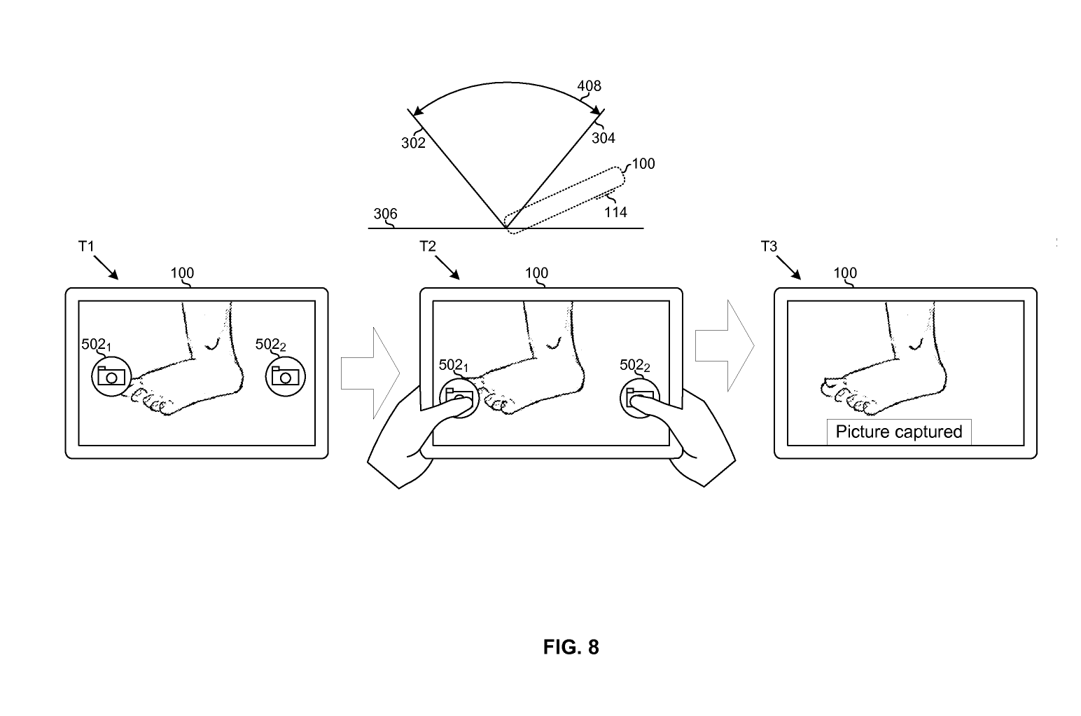

Now referring to FIG. 9, as shown at the top of the figure, the orientation of the device 100 in FIG. 9 is outside the range indicated by line 408. Accordingly, in FIG. 9, a photograph is triggered in response to a second-mode input. At time T1 in FIG. 9, the device 100 is ready to take a photograph. In the example implementation depicted in FIG. 9, the second-mode input is a long press (i.e., a press and hold of, for example 2-3 seconds) of button 502. The likelihood of an inadvertent long press of button 502 may be less than the likelihood of an inadvertent touch of the single button 502 in FIG. 5. Accordingly, in response to a user pressing button 502 from time T2 to T3, a photo capture is triggered and the captured photo is available a short time later (e.g., based on processing delays, exposure time, etc.) at time T4. In an example implementation, while the orientation of the device 100 is outside the range indicated by line 408, the device 100 indicates that the shutter is “locked;” a long press of button 502 as described in FIG. 9, however, overrides the shutter lock and triggers a photo capture.

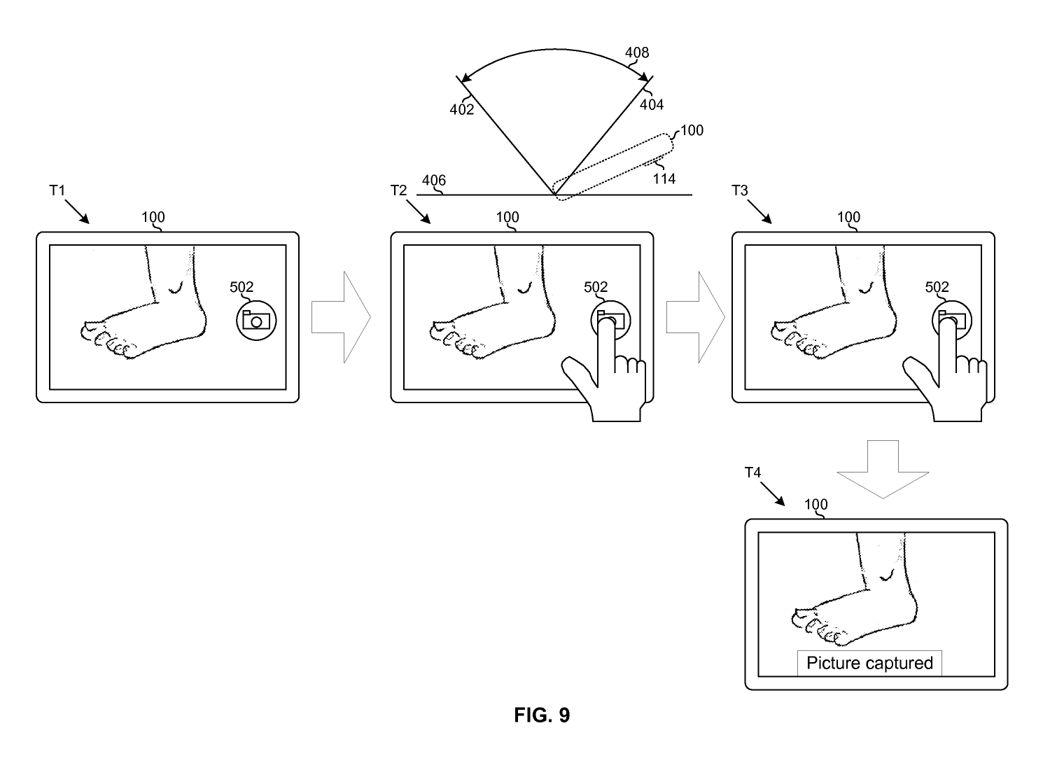

Now referring to FIG. 10, as shown at the top of the figure, the orientation of the device 100 in FIG. 10 is outside the range indicated by line 408. Accordingly, in FIG. 10, a photograph is triggered in response to a second-mode input. At time T1 in FIG. 10, the device 100 is ready to take a photograph. In the example implementation depicted in FIG. 10, the second-mode input is a long swipe of slide control 902. The likelihood of an inadvertent swipe along the length of control 902 may be less than the likelihood of an inadvertent touch of the single button 502 in FIG. 5. Accordingly, in response to a swiping of slide control 902 at time T2, a photo capture is triggered and the captured photo is available a short time later (e.g., based on processing delays, exposure time, etc.) at time T3.

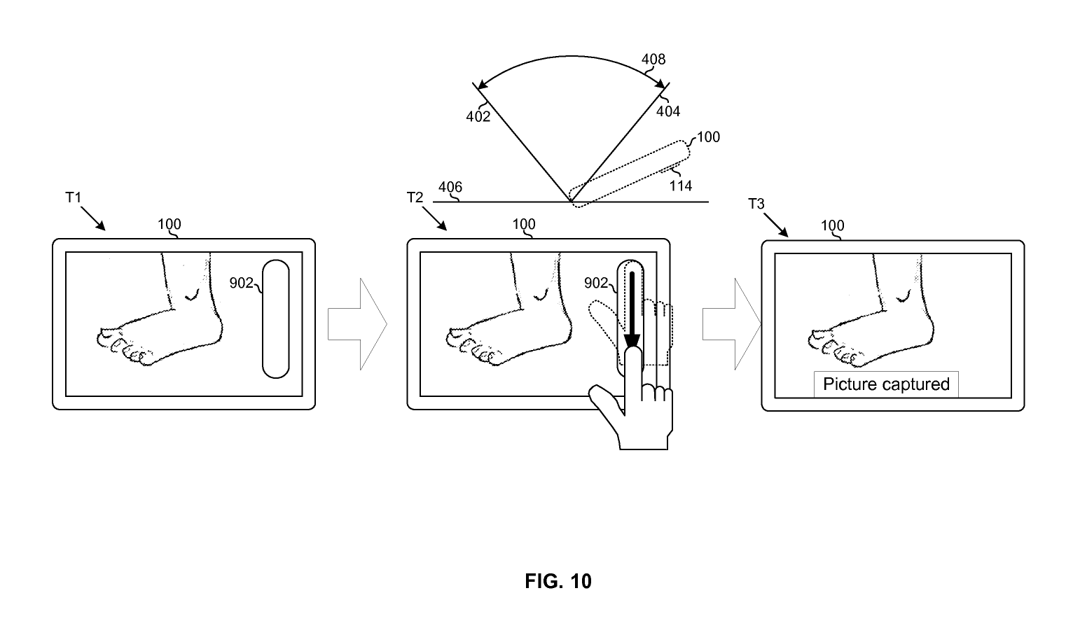

FIG. 11 is a flowchart illustrating an example process for guarding against inadvertent photos. The example process begins with block 1102 when the electronic device 100 (FIG. 1) is ready to capture a photograph. Where the device 100 is a phone or a tablet, for example, it may be ready to capture a photograph when a camera application of the device has been launched and is waiting for user input. Where the device 100 is a standalone camera, for example, it may be ready to capture a photograph when a control is switched to “capture” (or similar) as opposed to “playback” (or similar).

In block 1104, a mode of operation of the device 100 is selected based on orientation of the device 100. In instances that the device 100 is in a first orientation (e.g., angle of device 100 relative to the ground is less than a first threshold and/or greater than a second threshold), a first mode of operation is selected and the process advances to block 1006.

In block 1106, the device 100 waits for a first-mode input that will trigger a photo capture. The first-mode input may comprise, for example, a single touch of a single button, a single voice command, relatively-short and/or simple gesture, and/or some other input that may be relatively-likely to occur inadvertently.

In block 1108, upon receiving a first-mode input, a capture of a photograph is triggered.

Returning to block 1104, in instances that the device 100 is in a second orientation (e.g., angle of device 100 relative to the ground is greater than a first threshold and/or less than a second threshold), a second mode of operation is selected and the process advances to block 1110.

In block 1110, the device 100 waits for a second-mode input that will trigger a photo capture. The second-mode input may comprise, for example, multiple touches of one or more buttons, a voice command, a combination of one or more touches and one or more voice commands, a relatively-long and/or ornate gesture, and/or some other input that may be relatively-unlikely to occur inadvertently.

In block 1112, upon receiving a second-mode input, a capture of a photograph is triggered.

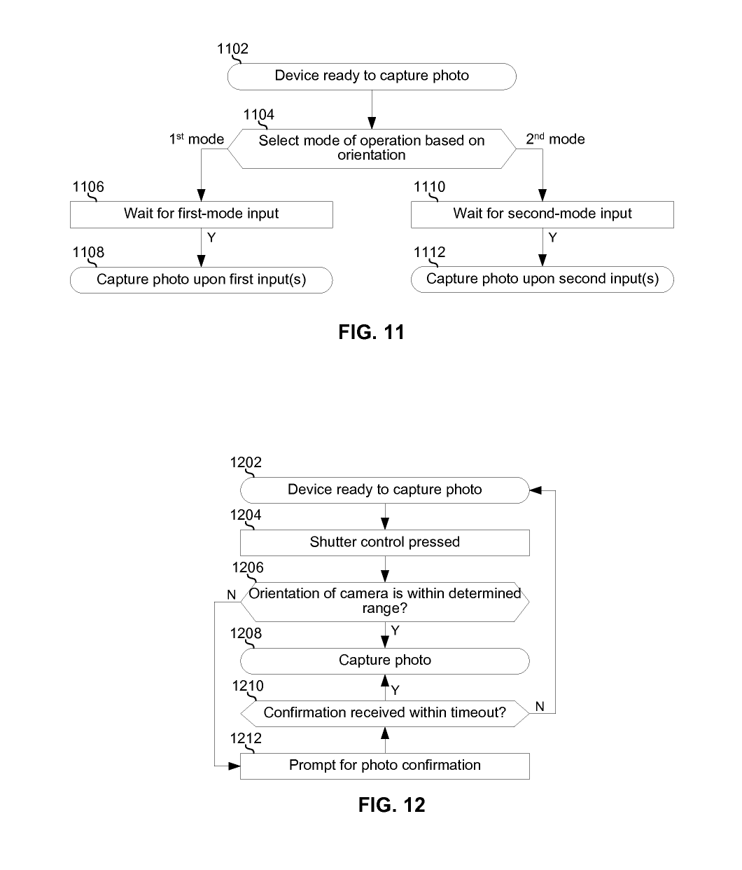

FIG. 12 is a flowchart illustrating an example process for guarding against inadvertent photos. The example process begins with block 1202 when the electronic device 100 (FIG. 1) is ready to capture a photograph. Where the device 100 is a phone or a tablet, for example, it may be ready to capture a photograph when a camera application of the device has been launched and is waiting for user input. Where the device 100 is a standalone camera, for example, it may be ready to capture a photograph when a control is switched to “capture” (or similar) as opposed to “playback” (or similar).

In block 1204, a shutter control of the device 100 (e.g., button 502 (FIG. 5)) is pressed.

In block 1206, the electronic device 100 determines whether its orientation is within a determined range (e.g., the range corresponding to line 408 in FIG. 4). If so, then in block 1208 a photo is captured.

Returning to block 1206, if the orientation is not within the determined range, the process advances to block 1212.

In block 1212, the electronic device prompts the user to confirm that a photo capture is desired. The prompt may be visual, audible, tactile, and/or any combination of the three.

In block 1210, if the user provides the necessary input (e.g., touch, voice command, gesture, and/or the like) to confirm that a photo capture is desired, then in block 1208 a photo is captured.

Returning to block 1210, if a timeout occurs before the user provides the necessary input to confirm that photo capture is desired, the process returns to block 1202.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform as described herein

Accordingly, the present method and/or system may be realized in hardware, software, or a combination of hardware and software. The present method and/or system may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While aspects of methods and systems have been described with reference to certain implementations, it will be understood by those skilled in the art that various changes may be made and equivalents may be substituted without departing from the scope of this disclosure. In addition, many modifications may be made to adapt a particular situation or material to the teachings of this disclosure without departing from its scope. Therefore, it is intended that this disclosure not be limited to the particular implementations disclosed, but that it includes all implementations falling within the scope of the appended claims.

What is claimed is:

1. An electronic device comprising:
an image sensor;
an orientation sensor; and
a user interface, wherein:
if said orientation sensor is in a first orientation, then said electronic device triggers a photo capture via said image sensor in response to a first input to said user interface, and
if said orientation sensor is in a second orientation, then said electronic device triggers a capture via the image sensor in response to a second input to said user interface.

2. The electronic device of claim 1, wherein:
said first orientation is any orientation within a determined range of angles; and
said second orientation is any orientation outside of said determined range of angles.

3. The electronic device of claim 1, wherein:
said first input to said user interface requires a single user action.

4. The electronic device of claim 1, wherein said second input to said user interface requires a single user action.

5. The electronic device of claim 1, wherein said second input to said user interface requires multiple user actions.

6. The electronic device of claim 3, wherein:
said single user action is a touch of said user interface.

7. The electronic device of claim 4, wherein:
said single user action is a touch of said user interface.

8. The electronic device of claim 5, wherein:
said multiple user actions comprise multiple touches of said user interface.

9. The electronic device of claim 6, wherein:
said single user action is a touch of a first button of said user interface.

10. The electronic device of claim 7, wherein:
said single user action is a touch of a first button of said user interface.

11. The electronic device of claim 8, wherein:
said multiple user actions comprise multiple touches of said button of said user interface.

12. The electronic device of claim 3, wherein:
said single user action is a voice input via a microphone.

13. The electronic device of claim 4, wherein:
said single user action is a voice input via a microphone.

14. The electronic device of claim 5, wherein:
said multiple user actions comprise a press of said button of said user interface and a voice input via a microphone.

15. The electronic device of claim 3, wherein:
said single user action consists of a single gesture sensed by said user interface.

16. The electronic device of claim 4, wherein:
said single user action consists of a single gesture sensed by user interface.

17. The electronic device of claim 5, wherein:
said multiple user actions consists of a plurality of gestures sensed by user interface.

18. The electronic device of claim 1, wherein the electronic device is a wireless terminal or tablet computer.

19. A method performed by an electronic device comprising an image sensor, an orientation sensor, and a user interface, the method comprising:
determining, via said orientation sensor, an orientation of said electronic device;
while said determined orientation of said electronic device is a first orientation, triggering a photo capture via said image sensor in response to a first-mode input received said user interface; and
while said determined orientation of said electronic device is a second orientation, triggering a photo capture via said image sensor in response to a second-mode input received via said user interface.

20. The method of claim 19, wherein:
said first orientation is any orientation within a determined range of angles; and
said second orientation is any orientation outside of said determined range of angles.

21. An electronic device with camera function, wherein the device is configured such that:
trigger of an image capture while an orientation of said electronic device is within a determined range requires a first input; and
trigger of an image capture while an orientation of said electronic device is outside of said determined range requires said first input and a confirmatory input.
